(19) United States
(12) Patent Application Publication
(10) Pub. No.: US 2025/0368081 A1
(43) Pub. Date: Dec. 4, 2025

(54) BALANCED CURRENT SHARING BETWEEN ELECTRICAL VEHICLE (EV) CHARGING STATIONS

(71) Applicant: ADDÉNERGIE TECHNOLOGIES INC., Québec City (CA)

(72) Inventors: Daniel MAILLOUX, Lac-Beauport (CA); Matthieu LOOS, Québec City (CA)

(73) Assignee: ADDÉNERGIE TECHNOLOGIES INC., Québec City (CA)

(21) Appl. No.: 18/731,682

(22) Filed: Jun. 3, 2024

(51) Int. Cl. B60L 53/63; B60L 53/62; B60L 53/67; B60L 53/68

(52) U.S. Cl. CPC B60L 53/63; B60L 53/62; B60L 53/67; B60L 53/68

(57) ABSTRACT

Systems and methods for distributing current across a plurality of EV charging stations are described. The plurality of EV charging stations are in-use and connected as phase-to-phase loads in a three-phase electrical power system. A method may determine a maximum phase-to-phase current for the electrical system; determine a number of EV charging stations being in use and connected phase-to-phase on each phase of the electrical system; determine a maximum available current associated with each EV charging station; and send to each EV charging station, instructions to implement the maximum available current associated with each associated phase.

### FIELD

This application relates to distributing current between electric vehicle (EV) charging stations. More particularly, one or more embodiments pertain to distributing current between EV charging stations connected as a phase-to-phase loads in a three-phase electrical power system.

### BACKGROUND

An electric vehicle (EV) charging station (also known as an electric vehicle supply equipment (EVSE)) is an electrical device that supplies electrical power for recharging plug-in EVs, such as battery electric vehicles, and plug-in hybrid vehicles.

In North America, at present, Level 2 EV charging stations are often connected between two phases of a three-phase power system, at 208V, or between a single phase-to-ground at 277V (from 480V phase-to-phase rated voltage) or to a split-phase system at 240V. As a result, use of these EV charging stations presents a risk of unbalancing the three-phase system and opening the circuit if one phase becomes overloaded.

Improvements to the field are desired.

### BRIEF DESCRIPTION OF THE DRAWINGS

Embodiments are described in detail below, with reference to the following drawings:

FIG. 1 illustrates a power distribution network in accordance with embodiments of the present disclosure;

FIG. 2 shows a first example three phase electrical system, in accordance with embodiments of the present disclosure;

FIG. 3 shows a second example three phase electrical system corresponding to the first example three phase electrical system of FIG. 2, in accordance with embodiments of the present disclosure;

FIG. 4 shows a third example three phase electrical system having one phase overloaded and the circuit opened, in accordance with embodiments of the present disclosure;

FIG. 5 is a high-level operation diagram of an example EV charging station, in accordance with embodiments of the present disclosure;

FIG. 6 is a block diagram illustrating an example environment for distributing current among a plurality of EV charging stations, in accordance with embodiments of the present disclosure;

FIG. 7 is an example flowchart showing operations performed in accordance with a method for distributing current across a plurality of EV charging stations, in accordance with embodiments of the present disclosure; and

FIG. 8 is an example flowchart showing operations performed in accordance with a method for determining a maximum available current associated with each EV charging station, in accordance with embodiments of the present disclosure.

Like reference numerals are used in the drawings to denote like elements and features.

### DETAILED DESCRIPTION OF EXAMPLE EMBODIMENTS

In accordance with one aspect of the present disclosure, there is provided a computing system for distributing current across a plurality of electric vehicle (EV) charging stations, the plurality of EV charging stations connected phase to phase in a three-phase electrical system, the computing system comprising: a communications module; a processor coupled to the communications module; a memory coupled to the processor, the memory storing processor-executable instructions which, when executed, configure the system to: a) determine a maximum phase-to-phase current for the electrical system; c) determine a maximum available current associated with each AB phase EV charging station; d) send, via the communications module to each AB phase EV charging station, instructions to implement the maximum available current associated with each AB phase EV charging station; e) determine a number of BC phase EV charging stations of the plurality of EV charging stations, the BC phase EV charging station being in-use and connected phase-to-phase on a BC phase of the electrical system; f) determine a maximum available current associated with each BC phase EV charging station; g) send, via the communications module and to each BC phase EV charging station, instructions to implement the maximum available current associated with each BC phase EV charging station; h) determine a number of CA phase EV charging stations of the plurality of EV charging stations, the CA phase EV charging stations being in-use and connected phase-to-phase on a CA phase of the electrical system; i) determine a maximum available current associated with each CA phase EV charging station; and j) send, via the communications module and to each CA phase EV charging station, instructions to implement the maximum available current associated with each CA phase EV charging station.

In some implementations, the system is further configured to repeat steps b) through j).

In some implementations, determining the maximum available current associated with each AB phase EV charging station comprises dividing the maximum phase-to-phase current by the number of AB phase EV charging stations to obtain a calculated maximum phase-to-phase current associated with each AB phase EV charging station; determining the maximum available current associated with each BC EV charging station comprises dividing the maximum phase-to-phase current by the number of BC phase EV charging stations to obtain a calculated maximum phase-to-phase current associated with each BC phase EV charging station; and determining the maximum available current associated with each CA EV charging station comprises dividing the maximum phase-to-phase current by the number of third phase EV charging station to obtain a calculated maximum phase-to-phase current associated with each CA phase EV charging station.

In some implementations, determining the maximum available current associated with a particular AB phase EV charging station further comprises determining a lesser of the calculated maximum phase-to-phase current associated with each AB phase EV charging station and a rated current capability associated with the particular AB phase EV charging station; determining the maximum available current associated with a particular BC phase EV charging station further comprises determining the lesser of the calculated maximum phase-to-phase current associated with each BC phase EV charging station and a rated current capability associated with the particular BC phase EV charging station; and wherein determining the maximum available current associated with a particular CA phase EV charging station further comprises determining the lesser of the calculated maximum phase-to-phase current associated with each CA phase EV charging station and a rated current capability associated with the particular CA phase EV charging station.

In some implementations, the lesser of the calculated maximum phase-to-phase current associated with each AB phase charging station and the rated current capability associated with the particular AB phase EV charging station is determined to be the associated calculated maximum phase-to-phase current, and the system is further configured to: determine the maximum available current associated with the particular AB phase EV charging station to be the associated calculated maximum phase-to-phase current.

In some implementations, when the lesser of the calculated maximum phase-to-phase current associated each AB phase EV charging station and the rated current capability associated with the particular AB phase EV charging station is determined to be the associated rated current capability, the system is further configured to: determine the maximum available current associated with the particular AB phase EV charging station to be the associated rated current capability; determine an excess current value to be a difference between the associated calculated maximum phase-to-phase current and the associated rated current capability; and increase the maximum available current associated with at least one other particular AB phase EV charging station by an amount less than or equal to the excess current value.

In some implementations, determining the maximum available current associated with each AB phase EV charging station comprises: determining an aggregate requested current value in connection with the AB phase; dividing the maximum phase-to-phase current by the aggregate requested current value to obtain a factor; and determining the maximum available current associated with a particular AB phase EV charging station to be a product of the factor and a requested current value in connection with the particular AB phase EV charging station.

In some implementations, the system is further configured to: detect an event; and repeat steps b) through k).

In some implementations, the aggregate requested current value comprises at least one requested current value in connection with an AB phase EV charging station, and the at least one requested current value is determined from data received from a vehicle via one or more of vehicle telematics or an International Standards Organization (ISO) 15118 message.

In some implementations, the event is one or more of a change in at least one requested current value or a change in the number of AB phase EV charging stations being in-use and connected phase-to-phase on the AB phase of the electrical system.

In accordance with another aspect of the present disclosure, there is provided a computer-implemented method for distributing current across a plurality of EV charging stations, the plurality of EV charging stations being connected phase-to-phase in a three-phase electrical system, the method comprising: a) determining a maximum phase-to-phase current for the electrical system; b) determining a number of AB phase EV charging stations of the plurality of EV charging stations, the AB phase EV charging stations being in-use and connected phase-to-phase on an AB phase of the electrical system; c) determining a maximum available current associated with each AB phase EV charging station; d) sending to each AB phase EV charging station, instructions to implement the maximum available current associated with each AB phase EV charging station; e) determining a number of BC phase EV charging stations of the plurality of EV charging stations, the BC phase EV charging stations being in-use and connected phase-to-phase on a BC phase of the electrical system; f) determining a maximum available current associated with each BC phase EV charging station; g) sending to each BC phase EV charging station, instructions to implement the maximum available current associated with each BC phase EV charging station; h) determining a number of CA phase EV charging stations of the plurality of EV charging stations, the CA phase EV charging stations being in-use and connected phase-to-phase on a CA phase of the electrical system; i) determining a maximum available current associated with each CA phase EV charging station; and j) sending to each CA phase EV charging station, instructions to implement the maximum available current associated with each CA phase EV charging station.

In some implementations, the method further comprises repeating steps b) through j).

In some implementations, determining the maximum available current associated with each AB phase EV charging station comprises dividing the maximum phase-to-phase current by the number of AB phase EV charging stations to obtain a calculated maximum phase-to-phase current associated with each AB phase EV charging station; determining the maximum available current associated with each BC EV charging station comprises dividing the maximum phase-to-phase current by the number of BC phase EV charging stations to obtain a calculated maximum phase-to-phase current associated with each BC phase EV charging station; and determining the maximum available current associated with each CA EV charging station comprises dividing the maximum phase-to-phase current by the number of third phase EV charging station to obtain a calculated maximum phase current associated with each CA phase EV charging station.

In some implementations, determining the maximum available current associated with a particular AB phase EV charging station further comprises determining a lesser of the calculated maximum phase-to-phase current associated with each AB phase EV charging station and a rated current capability associated with the particular AB phase EV charging station; determining the maximum available current associated with a particular BC phase EV charging station further comprises determining the lesser of the calculated maximum phase-to-phase current associated with each BC phase EV charging station and a rated current capability associated with the particular BC phase EV charging station; and determining the maximum available current associated with a particular CA phase EV charging station further comprises determining the lesser of the calculated maximum phase-to-phase current associated with each CA phase EV charging station and a rated current capability associated with the particular CA phase EV charging station.

In some implementations, when the lesser of the calculated maximum phase-to-phase current associated with each AB phase charging station and the rated current capability associated with the particular AB phase EV charging station is determined to be the associated calculated maximum phase-to-phase current, the method further comprises: determining the maximum available current associated with the particular AB phase EV charging station to be the associated calculated maximum phase-to-phase current.

In some implementations, when the lesser of the calculated maximum phase-to-phase current associated with each AB phase EV charging station and the rated current capability associated with the particular AB phase EV charging station is determined to be the associated rated current capability, the method further comprises: determining the maximum available current associated with the particular AB phase EV charging station to be the associated rated current capability; determining an excess current value to be a difference between the associated calculated maximum phase-to-phase current and the associated rated current capability; and increasing the maximum available current associated with at least one other particular AB phase EV charging station by an amount less than or equal to the excess current value.

In some implementations, determining the maximum available current associated with each AB phase EV charging station comprises: determining an aggregate requested current value in connection with the AB phase; dividing the maximum phase-to-phase current by the aggregate requested current value to obtain a factor; and determining the maximum available current associated with a particular AB phase EV charging station to be a product of the factor and a requested current value in connection with the particular AB phase EV charging station.

In some implementations, the method further comprises detecting an event, and repeating steps b) through k).

In some implementations, the aggregate requested current value comprises at least one requested current value in connection with an AB phase EV charging station, and the at least one requested current value is determined from data received from a vehicle via one or more of vehicle telematics or an International Standards Organization (ISO) 15118 message.

In accordance with yet another aspect of the present application, there is provided a non-transitory, computer readable medium containing instructions which, when executed by a processor, cause the processor to: determine a maximum phase-to-phase current for a three-phase electrical system; determine a number of AB phase EV charging stations of a plurality of EV charging stations, the AB phase EV charging stations being in-use and connected phase-to-phase on an AB phase of the electrical system; determine a maximum available current associated with each AB phase EV charging station; send to each AB phase EV charging station, instructions to implement the maximum available current associated with each AB phase EV charging station; determine a number of BC phase EV charging stations of the plurality of EV charging stations, the BC phase EV charging station being in-use and connected phase-to-phase on a BC phase of the electrical system; determine a maximum available current associated with each BC phase EV charging station; send to each BC phase EV charging station, instructions to implement the maximum available current associated with each BC phase EV charging station; determine a number of CA phase EV charging stations of the plurality of EV charging stations, the CA phase EV charging stations being in-use and connected phase-to-phase on a CA phase of the electrical system; determine a maximum available current associated with each CA phase EV charging station; and send to each CA phase EV charging station, instructions to implement the maximum available current associated with each CA phase EV charging station.

In the present application, the term “and/or” is intended to cover all possible combinations and subcombinations of the listed elements, including any one of the listed elements alone, any subcombination, or all of the elements, and without necessarily excluding additional elements.

In the present application, the phrase “at least one of . . . or . . . ” is intended to cover any one or more of the listed elements, including any one of the listed elements alone, any subcombination, or all of the elements, without necessarily excluding any additional elements, and without necessarily requiring all of the elements.

As noted, Level 2 EV charging stations are often connected between two phases of a three-phase power system, at 208V, or 240V, 277V, for example. As a result, use of these EV charging stations presents a risk of unbalancing the three-phase system and opening the circuit.

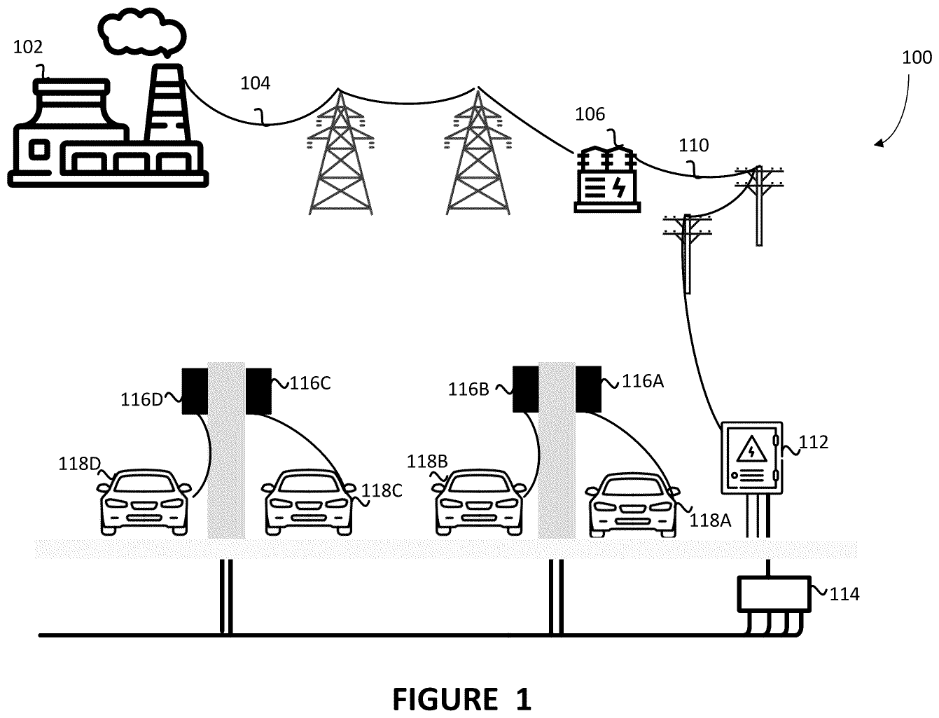

FIG. 1 illustrates an example power distribution network 100 in accordance with embodiments of the present disclosure. Alternating current (AC) is generated at a power generator 102, which may represent a power source such as those using fossil fuels, nuclear, solar, wind, or hydroelectric power. Power transmission lines 104 transmit the AC between the power generator 102 and a power substation 106, which changes the voltage of the AC for more efficient power distribution. The power substation 106 connects to power distribution lines 110. The power distribution lines 110 transmit AC from the power substation 106 to an electrical panel 112. Electricity may then be provided by the electrical panel 112 to a plurality of EV charging stations 116A-D via a junction box 114. In the example power distribution network 100, each EV charging station 116A-D is shown “in-use”, meaning each EV charging station is actively providing current to an EV 118A-D, and is operating as a load in the example power distribution network 100. It will be appreciated that a charging station may be of various types. In some embodiments, the charging station may be, for example, a charging station manufactured by AddEnergie™ Technologies Inc, such as the CoRe+™ charging station, for example.

Although the example power distribution network 100 illustrates only four EV charging stations 116A-D, some networks may charge dozens or even hundreds of EVs simultaneously, in accordance with the requirements of specific applications in accordance with embodiments of the present disclosure.

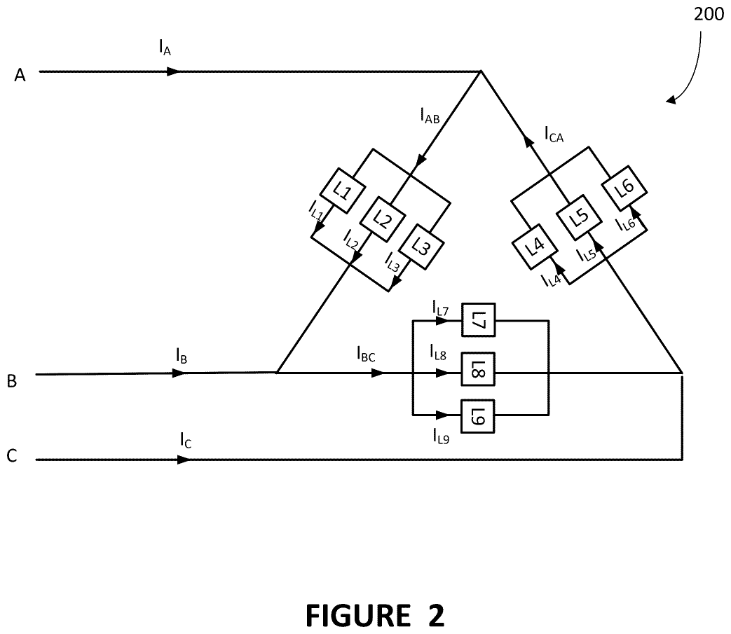

Reference is now made to FIG. 2, which illustrates a first example three phase electrical system 200. The first example three phase electrical system is balanced, meaning the current, which is alternating, of each of the first, second, and third phase-to-phase conductors AB, BC, CA is equal in magnitude but is shifted by 120 degrees.

As shown in FIG. 2, first, second, and third phase conductors A, B, C carry respective first, second and third phase currents I_{A}, I_{B}, I_{C}. As further shown, a first phase-to-phase conductor AB of the delta circuit extends between the first and second phase conductors A,B; a second phase-to-phase conductor BC of the delta circuit extends between the second and third phase conductors B,C; and a third phase-to-phase conductor CA of the delta circuit extends between the third and first phase conductors C,A.

Three parallel loads are shown across each of the illustrated first, second, and third phase-to-phase conductors AB, BC, CA. A first set of three parallel loads L1, L2, L3 are shown across the first phase-to-phase conductor AB, a second set of three parallel loads L7, L8, L9 are shown across the second-to-phase conductor BC, and a third set of parallel loads L4, L5, L6 are shown across the third phase-to-phase conductor CA. Each of the loads L1-L9 represent an EV charging station, and the placement of the loads L1-L9 represent an example placement of EV charging stations within a three-phase electrical system. Each load L1-L9 is shown drawing a corresponding load current I_{L1}-I_{L9}. As noted, the illustrated three-phase electrical system is balanced, meaning the current, which is alternating, of each phase is equal in magnitude but is shifted by 120 degrees.

A maximum phase current I_{phaseMax}, (in connection with illustrated first, second and third phase currents I_{A}, I_{B}, I_{C}) may be configured when the EV charging stations L1-L9 are initially installed. The maximum phase current, I_{phaseMax}, may be configured by a service or installation technician, such as an electrician. The maximum phase current, I_{phaseMax}, may be the maximum phase current that is associated with the breakers for the respective phase conductors A, B, C. For example, the maximum phase current, I_{phaseMax}, (i.e., the maximum value of each of the first, second and third line currents I_{A}, I_{B}, I_{C}) may be 120 A. As a result, the maximum phase-to-phase current, I_{phase-to-phaseMax} (i.e., the maximum value of each of the first, second and third phase-to-phase currents I_{AB}, I_{BC}, I_{CA}) will be equal to I_{phaseMax} divided by √3:

$${I}_{phase - to - phaseMax} = \frac{{I}_{phaseMax}}{\sqrt{3}}$$

For example, assuming I_{phaseMax}=120 A, I_{phase-to-phaseMax}, (the maximum value of I_{AB}, I_{BC}, I_{CA}), may be calculated as 69.28 A.

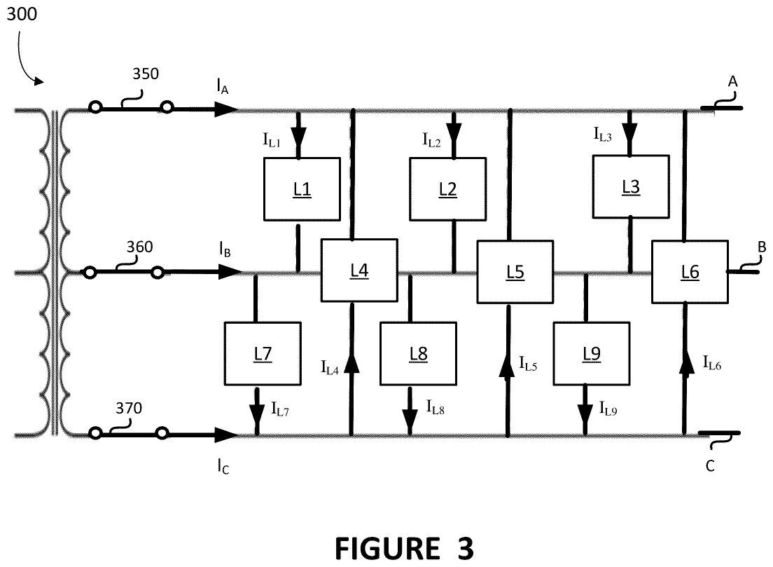

Reference is now made to FIG. 3, which is a second example three-phase electrical system 300 corresponding to the first example electrical system 200 of FIG. 2, in accordance with embodiments of the present disclosure. As with the first example three phase electrical system 200 of FIG. 2, the second example three-phase electrical system 300 is also balanced, meaning the current, which is alternating, of each phase is equal in magnitude but is shifted by 120 degrees.

The second example three-phase electrical system 300 includes the first, second and third phase conductors A, B, C, which are shown carrying respective first, second and third phase currents I_{A}, I_{B}, I_{C}. Each of the first, second and third phase conductors A, B, C are shown including a respective first, second, and third breaker 350, 360, 370. The first set of parallel loads L1, L2, and L3 are shown drawing respective load currents I_{L1}, I_{L2}, I_{L3} across the first phase-to-phase conductor AB; the second set of parallel loads L7, L8, L9 are shown drawing respective load currents I_{L7}, I_{L8}, I_{L9} across the second phase-to-phase conductor BC; and the third set of parallel loads L4, L5, L6 are shown drawing respective currents I_{L4}, I_{L5}, I_{L6} across the third phase-to-phase conductor CA. As noted with respect to FIG. 2, each of the loads L1-L9 represent an EV charging station, and the placement of the first through ninth loads L1-L9 represents an example placement of EV charging stations within a three-phase electrical system.

As noted with respect to FIG. 2, the maximum phase current, I_{phaseMax}, (i.e., the maximum value of each of the first, second and third phase currents I_{A}, I_{B}, I_{C}) may be 120 A, which may be the maximum current that is associated with the first, second and third breakers 350, 360, 370.

In the example of FIG. 3, each load current I_{L1}-I_{L9} is 23 A, and each phase current I_{A}, I_{B}, I_{C} is 119 A. As such, the second example three-phase electrical system 300 is balanced.

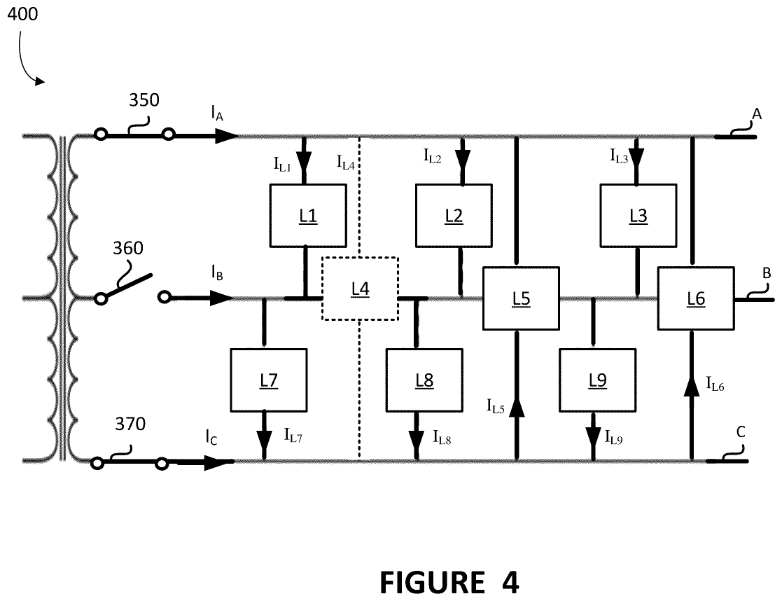

Sometimes, however, a load in a three-phase electrical system may become unbalanced. Reference is now made to FIG. 4, which is a third example three-phase electrical system 400, in accordance with examples of the present disclosure. The third example three-phase electrical system 400 illustrates an unbalanced three phase electrical system.

Similar to the second example electrical system 300 (FIG. 3), the first, second and third phase conductors A, B, C are shown carrying respective first, second and third phase currents I_{A}, I_{B}, I_{C}. Each of the first, second, and third phase conductors A, B, C includes a respective breaker 350, 360, 370. The first, second, and third loads L1, L2, L3 are shown drawing respective currents I_{L1}, I_{L2}, I_{L3} across the first phase-to-phase conductor AB; the fifth and sixth loads L5, L6 are shown drawing respective currents I_{L5}, I_{L6} across the third phase-to-phase conductor CA; and seventh, eighth, and ninth loads L7, L8, L9 are shown drawing respective currents I_{L7}, I_{L8}, I_{L9} across the second phase-to-phase conductor BC. As noted with respect to FIG. 2, each of the loads L1-L9 represents an EV charging station, and the placement of the loads L1-L9 represent an example placement of EV charging stations within a three-phase electrical system.

It will be noted that the third example three-phase electrical system 400 is distinct from the second example three-phase electrical system 300 (FIG. 3) in that the fourth load L4 is illustrated as being disconnected from the circuit. In other words, the EV charging station represented by the fourth load L4 is illustrated as being offline. The fourth line current I_{L4} may be described as being equal to 0 A.

As a result of the disconnection of the fourth load L4 from the circuit, the second phase conductor B is overloaded and the current values of the first, second and third phase currents I_{A}, I_{B}, I_{C} and the current values of the load currents I_{L1}-I_{L9} of the third example electrical system 400 are changed with respect to the corresponding current values of the second example three-phase electrical system 300 (FIG. 3). For example, each of the remaining loads L1-L3, L5-L9 now draw 26 A of current. The first and third phase currents I_{A}, I_{C} are each equal to 113 A, and the second phase current I_{B} is equal to 135 A. As 135 A is greater than the maximum value of phase current I_{B} of 120 A, the second breaker 360 corresponding to the second line conductor B is illustrated as open.

In order to avoid the risk of an unbalanced three-phase electrical system, certain systems and methods are proposed by the present disclosure.

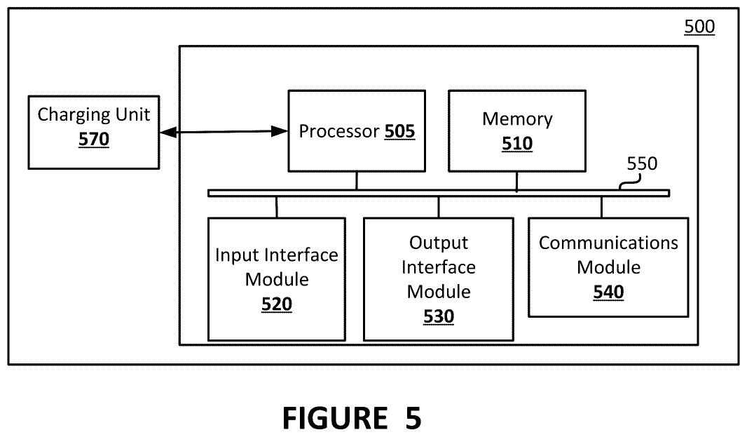

Reference is made to FIG. 5, which is a high-level operation diagram of an example EV charging station 500. The example EV charging station 500 includes a variety of modules. For example, as illustrated, the example EV charging station 500, may include a processor 505, a memory 510, an input interface module 520, an output interface module 530, and a communications module 540. As illustrated, the foregoing example modules of the example EV charging station 500 are in communication over a bus 550.

The processor 505 is a hardware processor. The processor 505 may, for example, be one or more ARM, Intel x86, PowerPC processors or the like.

The memory 510 allows data to be stored and retrieved. The memory 510 may include, for example, random access memory, read-only memory, and persistent storage. Persistent storage may be, for example, flash memory, a solid-state drive or the like. Read-only memory and persistent storage are a computer-readable medium. A computer-readable medium may be organized using a file system such as may be administered by an operating system governing overall operation of the example EV charging station 500.

The input interface module 520 allows the example EV charging station 500 to receive input signals. Input signals may, for example, correspond to input received from a user. The input interface module 520 may serve to interconnect the example EV charging station 500 with one or more input devices. Input signals may be received from input devices by the input interface module 520. Input devices may, for example, include one or more of a touchscreen input, keyboard, trackball or the like. In some implementations, all or a portion of the input interface module 520 may be integrated with an input device. For example, the input interface module 520 may be integrated with one of the aforementioned example input devices.

The output interface module 530 allows the example EV charging station 500 to provide output signals. Some output signals may, for example allow provision of output to a user. The output interface module 530 may serve to interconnect the example EV charging station 500 with one or more output devices. Output signals may be sent to output devices by output interface module 530. Output devices may include, for example, a display screen such as, for example, a liquid crystal display (LCD), a touchscreen display. Additionally, or alternatively, output devices may include devices other than screens such as, for example, a speaker, indicator lamps (such as for, example, light-emitting diodes (LEDs)), and printers. In some implementations, all or a portion of the output interface module 530 may be integrated with an output device. For example, the output interface module 530 may be integrated with one of the aforementioned example output devices.

The communications module 540 allows the example EV charging station 500 to communicate with other electronic devices and/or various communications networks. For example, the communications module 540 may allow the example EV charging station 500 to send or receive communications signals. Communications signals may be sent or received according to one or more protocols or according to one or more standards. For example, the communications module 540 may allow the example EV charging station 500 to communicate via a mesh network, according to one or more standards such as Zigbee™, or the like. The communications module 540 may allow the example EV charging station 500 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like. In some implementations, all or a portion of the communications module 540 may be integrated into a component of the example EV charging station 500. For example, the communications module may be integrated into a communications chipset.

Software comprising instructions is executed by the processor 505 from a computer-readable medium. For example, software may be loaded into random-access memory from persistent storage of memory 510. Additionally, or alternatively, instructions may be executed by the processor 505 directly from read-only memory of memory 510.

A charging unit 570 may be included in the example EV charging station 500. The charging unit may include an EV connector, such as a SAE J1772 or J3400 connector adapted to couple to a receiving connector on an EV. The processor 505 may communicate with the charging unit 570 via the SAE J1772 protocol, for example.

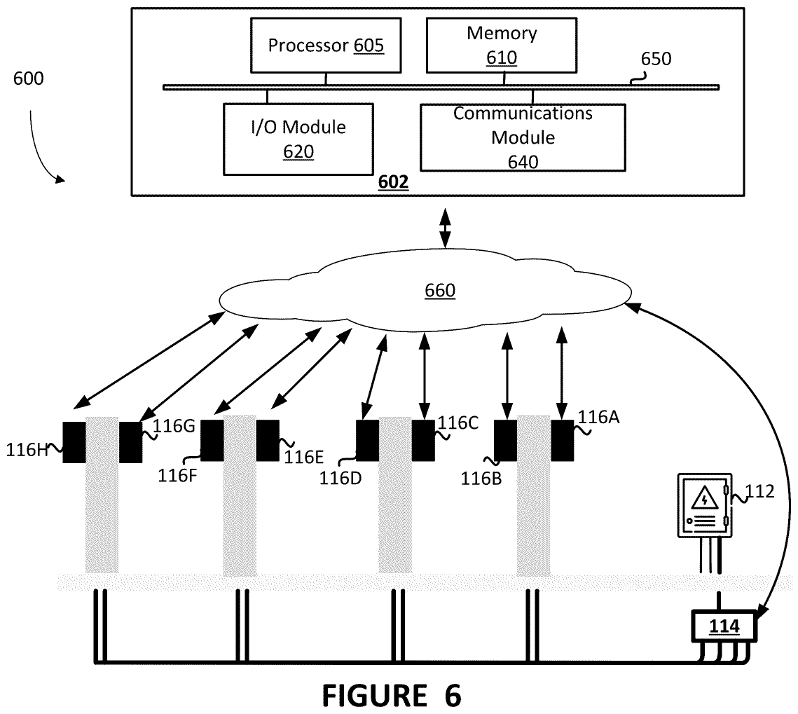

FIG. 6 is a block diagram illustrating an example environment 600 for managing the distribution of current between electric vehicle (EV) charging stations.

As shown, the example environment 600 includes a computing system 602 and a plurality of EV charging stations 116A-H in communication through a network 660.

As noted, the plurality of EV charging stations 116A-H are used for providing electricity to an electric vehicle (not shown). It will be appreciated that the charging stations 116A-H may be of various types. In some embodiments, the plurality of EV charging stations may be CoRe+™ charging stations manufactured by AddEnergie™ Technologies Inc., or the like. In some embodiments, the plurality of EV charging stations 116A-H operate according to the SAE J1772 standard, or the like. Although the example environment 600 illustrates eight EV charging stations 116A-H, some environments may include a greater or lesser number of EV charging stations.

The example environment 600 also includes the electrical panel 112, which provides electricity to the plurality of EV charging stations 116A-H via the junction box 114. In some embodiments, the junction box 114 may contain a communication gateway.

The plurality of EV charging stations 116A-H may communicate with the computing system 602 through the network 660. In some embodiments, the plurality of EV charging stations 116A-H may communicate with one another. Such communication may be by way of the network 660 or via another means of communication. By way of example, in some implementations, the plurality of EV charging stations 116A-H may communicate with one another and with the computing system 602 via the network 660, which may be, for example, a wireless mesh network operating according to the Zigbee™ standard. In some embodiments, the EV charging stations 116A-H may not communicate with one another directly, and their communication may be coordinated by a local or cloud based centralized system.

While the computing system 602 is shown as a standalone system, in some embodiments, the plurality of EV charging stations 116A-H may communicate with one or more cloud platforms, rather than with a stand-alone computing system 602. A cloud platform is a collection of computing resources, including servers, managed by a cloud service provider. A cloud platform may comprise data centers located in various remote locations. Each data center may comprise multiple physical servers. Examples of cloud platforms include Amazon Web Services (AWS), Microsoft Azure, and Google Cloud Platform (GCP), for example.

The computing system 602 includes a variety of modules. For example, as illustrated, the computing system 602 may include a processor 605, a memory 610, a communications module 640 and an input/output (I/O) module 620. As further illustrated, the foregoing example modules of the computing system 602 are in communication over a bus 650.

The processor 605 is a hardware processor. The processor 605 may, for example, be one or more ARM, Intel x86, PowerPC processors or the like.

The memory 610 allows data to be stored and retrieved. The memory 610 may include, for example, random access memory, read-only memory, and persistent storage. Persistent storage may be, for example, flash memory, a solid-state drive or the like. Read-only memory and persistent storage are a computer-readable medium. A computer-readable medium may be organized using a file system such as may be administered by an operating system governing overall operation of the computing system 602.

The communications module 640 allows the computing system 602 to communicate with other electronic devices and/or various communications networks. For example, the communications module 640 may allow the computing system 602 to send or receive communications signals. Communications signals may be sent or received according to one or more protocols or according to one or more standards. For example, the communications module 640 may allow the computing system 602 to communicate via a mesh network, according to one or more standards such as Zigbee™, or the like. The communications module 640 may allow the computing system 602 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like. In some implementations, all or a portion of the communications module 640 may be integrated into a component of the computing system 602. For example, the communications module 640 may be integrated into a communications chipset.

Software comprising instructions is executed by the processor 605 from a computer-readable medium. For example, software may be loaded into random-access memory from persistent storage of memory 610. Additionally, or alternatively, instructions may be executed by the processor 605 directly from read-only memory of memory 610.

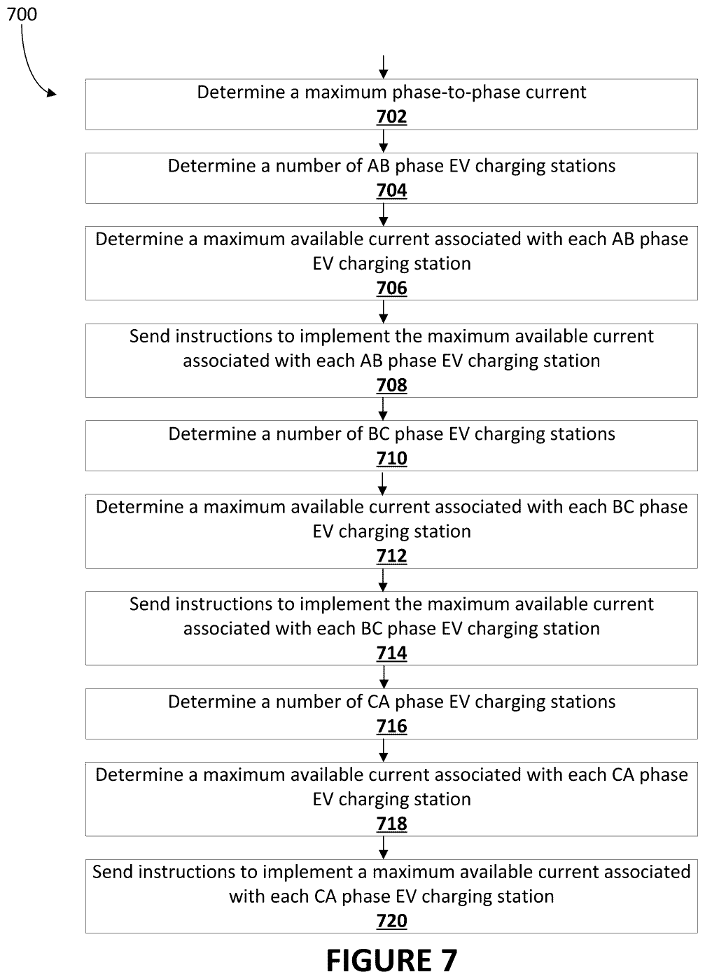

Reference is now made to FIG. 7, which is an example flowchart showing operations performed in accordance with a method 700 for distributing current across a plurality of EV charging stations, the plurality of EV charging stations being in-use in a three-phase electrical power system. The method 700 may be implemented by a computing system such as the computing system 602 of FIG. 6. In some embodiments, the method 700 may be performed by a computing system physically located at one of the plurality of EV charging stations. In some embodiments, the method 700 may be performed by a stand-alone computing system remote to the plurality of EV charging stations. In some embodiments, the method 700 may be performed by one or more components of a cloud platform.

Specifically, the method 700 may be performed, for example, by the processor 605 of the computing system 602 executing software comprising instructions such as may be stored in the memory 610 of the computing system 602. More particularly, processor-executable instructions may, when executed, configure a processor 605 of the computing system 602 to perform all or parts of the method 700.

At the operation 702, the system determines a maximum phase-to-phase current for the electrical system. The maximum phase-to-phase current will be equal to the maximum phase current divided by √3, assuming the system is balanced:

$${I}_{phase - to - phaseMax} = \frac{{I}_{phaseMax}}{\sqrt{3}}$$

For example, assuming I_{phaseMax}=120 A, I_{phase-to-phaseMax} may be calculated as 69.28 A.

At the operation 704, the system determines a number of AB phase EV charging stations of the plurality of EV charging stations, the AB phase EV charging stations being in-use and connected phase-to-phase on an AB phase of the electrical system.

For example, with reference to the first example electrical system 200 of FIG. 2, the number of AB phase EV charging stations being in-use and connected phase-to-phase on the AB phase is three (L1, L2 and L3).

In some embodiments, the system may record the connection particulars of an EV charging station at the time of connection to the electrical system. For example, a service or installation technician, such as an electrician, may indicate how the EV infrastructure is wired during the commissioning process. In some embodiments, each EV charging station may provide notification to the system to dynamically indicate whether or not the EV charging station is in use. In this way, the system may determine the number of AB phase EV charging stations being in-use and connected phase-to-phase on the AB phase of the electrical system.

At the operation 706, the system determines a maximum available current associated with each AB phase EV charging station.

In some embodiments, a calculated maximum available current associated with each AB phase EV charging station, I_{ABloadMax}, may be determined by dividing the maximum phase-to-phase current, I_{phase-to-phaseMax}, by the number of AB phase EV charging stations being in-use and connected phase-to-phase on the AB phase of the electrical system, n_{AB}:

$${I}_{ABloadMax} = \frac{{I}_{phase - phaseMax}}{{n}_{AB}}$$

For example, if the maximum phase-to-phase current, I_{phase-to-phaseMax}, is 69.23 A, and there are three, in-use EV charging stations across the AB phase (n_{AB}=3), the system may determine the calculated maximum available current associated with each AB phase EV charging station, I_{ABloadMax}, to be 23.07 A.

In some embodiments, the system may then determine, for each particular AB phase EV charging station, the lesser of the calculated maximum phase-to-phase current and a rated current capability of the particular AB phase EV charging station. The maximum available current associated with each particular AB phase EV charging station may then be determined as the lesser of the calculated maximum phase-to-phase current and the rated current capability of the particular AB phase EV charging station.

In some implementations where the maximum available current associated with a particular AB phase EV charging station is determined to be the rated current capability of the particular AB phase EV charging station, the system may then determine an excess current value associated with the particular AB phase EV charging station. The excess current value may be a difference between the associated calculated maximum phase-to-phase current and the associated rated current capability of the particular AB phase EV charging station. Subsequently, the system may increase the maximum available current associated with at least one another AB phase EV charging station by an amount less than or equal to the excess current value.

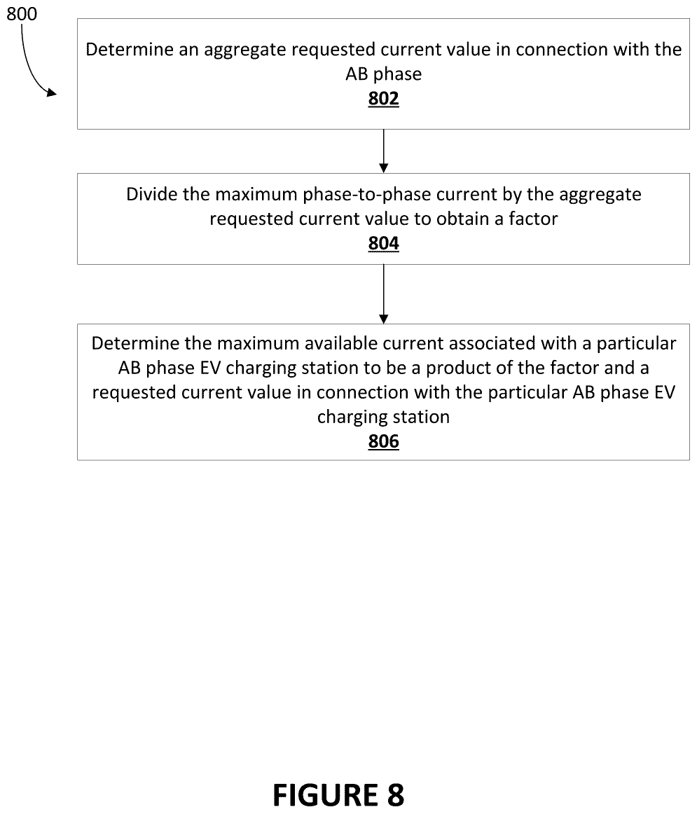

Reference is now made to FIG. 8, which is an example flowchart showing operations performed in accordance with a method 800 for determining a maximum available current associated with each AB phase EV charging station, in accordance with embodiments of the present disclosure. The method 800 may be implemented by a computing system such as the computing system 602 of FIG. 6. In some embodiments, the method 800 may be performed by a computing system physically located at one of the plurality of EV charging stations. In some embodiments, the method 800 may be performed by a stand-alone computing system remote to the plurality of EV charging stations. In some embodiments, the method 700 may be performed by one or more components of a cloud platform.

Specifically, the method 800 may be performed, for example, by the processor 605 (FIG. 6) of a computing system 602 executing software comprising instructions such as may be stored in the memory 610 of the computing system 602. More particularly, processor-executable instructions may, when executed, configure a processor 605 of the computing system 602 to perform all or parts of the method 800.

At the operation 802, the system determines an aggregate requested current value in connection with the AB phase.

For example, in some embodiments, the system may determine one or more requested current values. Each of the one or more requested current values may be associated with a particular vehicle in-use with an AB phase EV charging station. The requested current values may be determined in a number of ways. For example, a requested current value may be communicated by the associated particular vehicle via an ISO 15118 message or by vehicle telematics. As a further example, a requested current value may be communicated by a driver of the associated particular vehicle using a software application associated with a client device.

The one or more requested current values may be calculated by the system using parameters received from the associated vehicle and/or a driver of the associated vehicle. For example, the system may calculate a requested current value based on a received requested energy value, a voltage value, and an available time value, as follows:

$${I}_{requested = \frac{{E}_{requested}}{V \times {t}_{available}} ;}$$

where I_{requested} is the requested current, E_{requested} is the energy required by the vehicle, V is the voltage supplied by the EV charging station and t_{available} is the time the vehicle will be plugged into the EV charging station (e.g., a time limit associated with a parking spot).

As a further example, the system may calculate a requested current value based on a battery capacity value, a target state of charge (SOC) of the battery, an initial SOC of the battery, a voltage value, and an available time value, as follows:

$${I}_{requested = ( \frac{BattCap}{{SOC}_{target} - {SOC}_{initial}} ) \times \frac{1}{V \times {t}_{available}} ;}$$

where I_{requested} is the requested current, BattCap is the battery capacity, SOC_{target} is the target state of charge of the battery, SOCᵢₙᵢₜᵢₐₗ is the initial state of charge of the battery, V is the voltage supplied by the EV charging station and t_{available} is the time the vehicle will be plugged into the EV charging station (e.g., a time limit associated with a parking spot).

In some embodiments, the system may determine the aggregate requested current value in connection with the AB phase by calculating a summation of the particular requested current values associated with each vehicle in-use and connected phase-to-phase with the AB phase EV charging station.

At the operation 804, the system divides the maximum phase-to-phase current by the aggregate requested current value to obtain a factor.

In some embodiments, the system may perform the following calculation:

$$\sum {I}_{requested} = \frac{{I}_{phase - to - phaseMax}}{F} ;$$

where ΣI_{requested} is the aggregate request current value, I_{phase-to-phaseMax} is the maximum phase-to-phase current and F is the factor.

At the operation 806, the system may determine the maximum available current associated with each particular AB phase EV charging station to be a product of the factor and the requested current value in connection with the particular AB phase EV charging station.

For example, the system may perform the following calculation:

$${I}_{ABloadMax} = F \times {I}_{requested} ;$$

where I_{ABloadMax} is the maximum available current associated with a particular AB phase EV charging station; F is the factor, and I_{requested} is the requested current value in connection with the particular AB phase EV charging station.

Returning to the method 700 of FIG. 7, after the operation 706, the operation 708 is next.

At the operation 708, the system may send, via the communications module to each AB phase EV charging station, instructions to implement the maximum available current associated with each AB phase EV charging station.

At the operation 710, the system determines a number of BC phase EV charging stations of the plurality of EV charging stations, the BC phase EV charging stations being in-use and connected phase-to-phase on a BC phase of the electrical system.

For example, with reference to the first example electrical system 200 of FIG. 2, the number of BC phase EV charging stations being in-use and connected phase-to-phase on the BC phase as is three.

In some embodiments, the system may record the connection particulars of an EV charging station at the time of connection to the electrical system. For example, a service or installation technician, such as an electrician, may indicate how the EV infrastructure is connected during the commissioning process. In some embodiments, the system may determine the number of BC phase EV charging stations that are in-use via proximity sensors. In this way, the system may determine the number of BC phase EV charging stations being in-use and connected phase-to-phase on the BC phase of the electrical system.

At the operation 712, the system determines a maximum available current associated with each BC phase EV charging station.

In some embodiments, a calculated maximum available current associated with each BC phase EV charging station, I_{BCloadMax}, may be determined by dividing the maximum phase-to-phase current, I_{phase-to-phaseMax}, by the number of BC phase EV charging stations being in-use and connected phase-to-phase on the BC phase, n_{BC}:

$${I}_{BCloadMax} = \frac{{I}_{phase - to - phaseMax}}{{n}_{BC}}$$

For example, if the maximum phase-to-phase current, I_{phase-tophaseMax}, is 69.23 A, and there are three, in-use EV charging stations across the BC phase (n_{BC}=3), the system may determine the calculated maximum available current associated with each BC phase EV charging station, I_{BCloadMax}, to be 23.07 A.

In some embodiments, the system may then determine, for each particular BC phase EV charging station, the lesser of the calculated maximum available current and a rated current capability of a particular BC phase EV charging station. The maximum available current associated with each particular BC phase EV charging station may then be determined as the lesser of the calculated maximum available current and the rated current capability of the particular BC phase EV charging station.

In implementations where the maximum available current associated with a particular BC phase EV charging station is determined to be the rated current capability of the particular BC phase EV charging station, the system may then determine an excess current value associated with the particular BC phase EV charging station. The excess current value may be a difference between the associated calculated maximum available current and the associated rated current capability of the particular BC phase EV charging station. Subsequently, the system may increase the maximum available current associated with at least one other BC phase EV charging station by the amount less than or equal to the excess current value.

At the operation 714, the system may send, via the communications module to each BC phase EV charging station, instructions to implement the maximum available current associated with each BC phase EV charging station.

At the operation 716, the system determines a number of CA phase EV charging stations of the plurality of EV charging stations, the CA phase EV charging stations being in-use and connected phase-to-phase on a CA phase of the electrical system.

For example, with reference to the first example electrical system 200 of FIG. 2, the number of CA phase EV charging stations being in-use is three.

In some embodiments, the system may record the connection particulars of an EV charging station at the time of connection to the electrical system. For example, a service or installation technician, such as an electrician, may indicate how the EV infrastructure is connected during the commissioning process. In some embodiments, the system may determine the number of CA phase EV charging stations that are in-use by the use of proximity sensors. In this way, the system may determine the number of CA phase EV charging stations being in-use and connected phase-to-phase on a CA phase of the electrical system.

At the operation 720, the system determines a maximum available current associated with each CA phase EV charging station.

In some embodiments, a calculated maximum available current associated with each CA phase EV charging station, I_{CAloadMax}, may be determined by dividing the maximum phase-to-phase current, I_{phase-to-phaseMax}, by the number of CA phase EV charging stations being in-use and connected phase-to-phase the CA phase, n_{cA}:

$${I}_{CAloadMax} = \frac{{I}_{phase - tophaseMax}}{{n}_{CA}}$$

For example, if the maximum phase-to-phase current, I_{phase-to-phaseMax}, is 69.23 A, and there are three, in-use EV charging stations across the CA phase (n_{CA}=3), the system may determine the calculated maximum available current associated with each CA phase EV charging station, I_{CAloadMax}, to be 23.07 A.

In some embodiments, the system may then determine, for each particular CA phase EV charging station, the lesser of the calculated maximum available current and a rated current capability of the particular CA phase EV charging station. The maximum available current associated with each particular CA phase EV charging station may then be determined as the lesser of the calculated maximum available current and the rated current capability of the particular CA phase EV charging station.

In implementations where the maximum available current associated with a particular CA phase EV charging station is determined to be the rated current capability of the particular CA phase EV charging station, the system may then determine an excess current value associated with the particular CA phase EV charging station. The excess current value may be a difference between the associated calculated maximum available current and the associated rated current capability of the particular CA phase EV charging station. Subsequently, the system may increase the maximum available current associated with at least one other CA phase EV charging station by an amount less than or equal to the excess current value.

At the operation 720, the system may send, via the communications module to each CA phase EV charging station, instructions to implement the maximum available current associated with each CA phase EV charging station.

In some embodiments, the system may be configured to repeat the operations 704 to 720 in response to an event. For example, in some embodiments, the event may be a change in at least one requested current value and the system may be configured to repeat the operations 704 to 720 when at least one EV station communicates a change in a requested current value. As a further example, the event may be a change in the number of in-use EV charging stations and the system may be configured to repeat the operations 704 to 720 whenever there is a change in the number of in-use EV charging stations.

In some embodiments, the system may be configured repeat the operations 704-720 on a periodic basis after a time period. For example, the system may be configured to repeat the operations 704 to 720 after a time period of 10 seconds. In this way, each EV charging station may be configured to draw an appropriate amount of current to ensure that the three-phase electrical system does not become unbalanced.

The various implementations presented above are merely examples and are in no way meant to limit the scope of this application. Variations of the innovations described herein will be apparent to persons of ordinary skill in the art, such variations being within the intended scope of the present application. In particular, features from one or more of the above-described example implementations may be selected to create alternative example implementations including a subcombination of features which may not be explicitly described above. In addition, features from one or more of the above-described example implementations may be selected and combined to create alternative example implementations including a combination of features which may not be explicitly described above. Features suitable for such combinations and subcombinations would be readily apparent to persons skilled in the art upon review of the present application as a whole. The subject matter described herein and in the recited claims intends to cover and embrace all suitable changes in technology.

What is claimed is:

1. A computing system for distributing current across a plurality of electric vehicle (EV) charging stations, the plurality of EV charging stations being connected phase-to-phase in a three-phase electrical system, the computing system comprising:
a communications module;
a processor coupled to the communications module;
a memory coupled to the processor, the memory storing processor-executable instructions which, when executed, configure the system to:
a) determine a maximum phase-to-phase current for the electrical system;
b) determine a number of AB phase EV charging stations of the plurality of EV charging stations, the AB phase EV charging stations being in-use and connected phase-to-phase on an AB phase of the electrical system;
c) determine a maximum available current associated with each AB phase EV charging station;
d) send, via the communications module and to each AB phase EV charging station, instructions to implement the maximum available current associated with each AB phase EV charging station;
e) determine a number of BC phase EV charging stations of the plurality of EV charging stations, the BC phase EV charging station being in-use and connected phase-to-phase on a BC phase of the electrical system;
f) determine a maximum available current associated with each BC phase EV charging station;
g) send, via the communications module and to each BC phase EV charging station, instructions to implement the maximum available current associated with each BC phase EV charging station;
h) determine a number of CA phase EV charging stations of the plurality of EV charging stations, the CA phase EV charging stations being in-use and connected phase-to-phase on a CA phase of the electrical system;
i) determine a maximum available current associated with each CA phase EV charging station; and
j) send, via the communications module and to each CA phase EV charging station, instructions to implement the maximum available current associated with each CA phase EV charging station.

2. The system of claim 1, wherein the system is further configured to:
repeat steps b) through j).

3. The system of claim 1,
wherein determining the maximum available current associated with each AB phase EV charging station comprises dividing the maximum phase-to-phase current by the number of AB phase EV charging stations to obtain a calculated maximum phase-to-phase current associated with each AB phase EV charging station;
wherein determining the maximum available current associated with each BC EV charging station comprises dividing the maximum phase-to-phase current by the number of BC phase EV charging stations to obtain a calculated maximum phase-to-phase current associated with each BC phase EV charging station; and
wherein determining the maximum available current associated with each CA EV charging station comprises dividing the maximum phase-to-phase current by the number of third phase EV charging station to obtain a calculated maximum phase-to-phase current associated with each CA phase EV charging station.

4. The system of claim 3,
wherein determining the maximum available current associated with a particular AB phase EV charging station further comprises determining a lesser of the calculated maximum phase-to-phase current associated with each AB phase EV charging station and a rated current capability associated with the particular AB phase EV charging station;
wherein determining the maximum available current associated with a particular BC phase EV charging station further comprises determining the lesser of the calculated maximum phase-to-phase current associated with each BC phase EV charging station and a rated current capability associated with the particular BC phase EV charging station; and
wherein determining the maximum available current associated with a particular CA phase EV charging station further comprises determining the lesser of the calculated maximum phase-to-phase current associated with each CA phase EV charging station and a rated current capability associated with the particular CA phase EV charging station.

5. The system of claim 4,
wherein when the lesser of the calculated maximum phase-to-phase current associated with each AB phase charging station and the rated current capability associated with the particular AB phase EV charging station is determined to be the associated calculated maximum phase-to-phase current, the system is further configured to:
determine the maximum available current associated with the particular AB phase EV charging station to be the associated calculated maximum phase-to-phase current.

6. The system of claim 4,
wherein when the lesser of the calculated maximum phase-to-phase current associated with each AB phase EV charging station and the rated current capability associated with the particular AB phase EV charging station is determined to be the associated rated current capability, the system is further configured to:
determine the maximum available current associated with the particular AB phase EV charging station to be the associated rated current capability;
determine an excess current value to be a difference between the associated calculated maximum phase-to-phase current and the associated rated current capability; and
increase the maximum available current associated with at least one other particular AB phase EV charging station by an amount less than or equal to the excess current value.

7. The system of claim 1, wherein determining the maximum available current associated with each AB phase EV charging station comprises:
determining an aggregate requested current value in connection with the AB phase;
dividing the maximum phase-to-phase current by the aggregate requested current value to obtain a factor; and
determining the maximum available current associated with a particular AB phase EV charging station to be a product of the factor and a requested current value in connection with the particular AB phase EV charging station.

8. The system of claim 7, wherein the system is further configured to:
detect an event; and
repeat steps b) through k).

9. The system of claim 8,
wherein the aggregate requested current value comprises at least one requested current value in connection with an AB phase EV charging station, and
wherein the at least one requested current value is determined from data received from a vehicle via one or more of vehicle telematics or an International Standards Organization (ISO) 15118 message.

10. The system of claim 9, wherein the event is one or more of a change in at least one requested current value or a change in the number of AB phase EV charging stations being in-use and connected phase-to-phase on the AB phase of the electrical system.

11. A computer-implemented method for distributing current across a plurality of EV charging stations, the plurality of EV charging stations being connected phase-to-phase in a three-phase electrical system, the method comprising:
a) determining a maximum phase-to-phase current for the electrical system;
b) determining a number of AB phase EV charging stations of the plurality of EV charging stations, the AB phase EV charging stations being in-use and connected phase-to-phase on an AB phase of the electrical system;
c) determining a maximum available current associated with each AB phase EV charging station;
d) sending, to each AB phase EV charging station, instructions to implement the maximum available current associated with each AB phase EV charging station;
e) determining a number of BC phase EV charging stations of the plurality of EV charging stations, the BC phase EV charging stations being in-use and connected phase-to-phase on a BC phase of the electrical system;
f) determining a maximum available current associated with each BC phase EV charging station;
g) sending to each BC phase EV charging station, instructions to implement the maximum available current associated with each BC phase EV charging station;
h) determining a number of CA phase EV charging stations of the plurality of EV charging stations, the CA phase EV charging stations being in-use and connected phase-to-phase on a CA phase of the electrical system;
i) determining a maximum available current associated with each CA phase EV charging station; and
j) sending to each CA phase EV charging station, instructions to implement the maximum available current associated with each CA phase EV charging station.

12. The method of claim 11, wherein the method further comprises:
repeating steps b) through j).

13. The method of claim 11,
wherein determining the maximum available current associated with each AB phase EV charging station comprises dividing the maximum phase-to-phase current by the number of AB phase EV charging stations to obtain a calculated maximum phase-to-phase current associated with each AB phase EV charging station;
wherein determining the maximum available current associated with each BC EV charging station comprises dividing the maximum phase-to-phase current by the number of BC phase EV charging stations to obtain a calculated maximum phase-to-phase current associated with each BC phase EV charging station; and
wherein determining the maximum available current associated with each CA EV charging station comprises dividing the maximum phase-to-phase current by the number of third phase EV charging station to obtain a calculated maximum phase current associated with each CA phase EV charging station.

14. The method of claim 13,
wherein determining the maximum available current associated with a particular AB phase EV charging station further comprises determining a lesser of the calculated maximum phase-to-phase current associated with each AB phase EV charging station and a rated current capability associated with the particular AB phase EV charging station;
wherein determining the maximum available current associated with a particular BC phase EV charging station further comprises determining the lesser of the calculated maximum phase-to-phase current associated with each BC phase EV charging station and a rated current capability associated with the particular BC phase EV charging station; and
wherein determining the maximum available current associated with a particular CA phase EV charging station further comprises determining the lesser of the calculated maximum phase-to-phase current associated with each CA phase EV charging station and a rated current capability associated with the particular CA phase EV charging station.

15. The method of claim 14,
wherein when the lesser of the calculated maximum phase-to-phase current associated with each AB phase charging station and the rated current capability associated with the particular AB phase EV charging station is determined to be the associated calculated maximum phase-to-phase current, the method further comprises:
determining the maximum available current associated with the particular AB phase EV charging station to be the associated calculated maximum phase-to-phase current.

16. The method of claim 14,
wherein when the lesser of the calculated maximum phase-to-phase current associated with each AB phase EV charging station and the rated current capability associated with the particular AB phase EV charging station is determined to be the associated rated current capability, the method further comprises:
determining the maximum available current associated with the particular AB phase EV charging station to be the associated rated current capability;
determining an excess current value to be a difference between the associated calculated maximum phase-to-phase current and the associated rated current capability; and
increasing the maximum available current associated with at least one other particular AB phase EV charging station by an amount less than or equal to the excess current value.

17. The method of claim 11, wherein determining the maximum available current associated with each AB phase EV charging station comprises:
determining an aggregate requested current value in connection with the AB phase;
dividing the maximum phase-to-phase current by the aggregate requested current value to obtain a factor; and
determining the maximum available current associated with a particular AB phase EV charging station to be a product of the factor and a requested current value in connection with the particular AB phase EV charging station.

18. The method of claim 17, wherein the method further comprises:
detecting an event; and
repeating steps b) through k).

19. The method of claim 18,
wherein the aggregate requested current value comprises at least one requested current value in connection with an AB phase EV charging station, and
wherein the at least one requested current value is determined from data received from a vehicle via one or more of vehicle telematics or an International Standards Organization (ISO) 15118 message.

20. A non-transitory, computer readable medium containing instructions which, when executed by a processor, cause the processor to:
a) determine a maximum phase-to-phase current for a three-phase electrical system;
b) determine a number of AB phase EV charging stations of a plurality of EV charging stations, the AB phase EV charging stations being in-use and connected phase-to-phase on an AB phase of the electrical system;
c) determine a maximum available current associated with each AB phase EV charging station;
d) send to each AB phase EV charging station, instructions to implement the maximum available current associated with each AB phase EV charging station;
e) determine a number of BC phase EV charging stations of the plurality of EV charging stations, the BC phase EV charging station being in-use and connected phase-to-phase on a BC phase of the electrical system;
f) determine a maximum available current associated with each BC phase EV charging station;
g) send to each BC phase EV charging station, instructions to implement the maximum available current associated with each BC phase EV charging station;
h) determine a number of CA phase EV charging stations of the plurality of EV charging stations, the CA phase EV charging stations being in-use and connected phase-to-phase on a CA phase of the electrical system;
i) determine a maximum available current associated with each CA phase EV charging station; and
j) send to each CA phase EV charging station, instructions to implement the maximum available current associated with each CA phase EV charging station.
